(19) United States
(12) Patent Application Publication
(10) Pub. No.: US 2025/0261636 A1
(43) Pub. Date: Aug. 21, 2025

(54) QUATERNARY AMMONIUM SANITIZING COMPOSITION

(71) Applicant: ECOLAB USA INC., Saint Paul, MN (US)

(72) Inventors: Derrick Anderson, Vadnais Heights, MN (US); Kelly Anne Rightmire, Saint Paul, MN (US)

(21) Appl. No.: 19/195,224

(22) Filed: Apr. 30, 2025

Related U.S. Application Data
(62) Division of application No. 17/302,350, filed on Apr. 30, 2021.
(60) Provisional application No. 63/017,961, filed on Apr. 30, 2020.

(51) Int. Cl. A01N 33/12; A01N 25/02; A01N 37/00

(52) U.S. Cl. CPC A01N 33/12; A01N 25/02; A01N 37/00

(57) ABSTRACT

Sanitizing compositions, including sanitizing rinse aid compositions, are provided and include antimicrobial quaternary ammonium compounds, namely alkyl dimethyl benzyl ammonium chlorides (ADBAC), alkyl dimethyl ethyl benzyl ammonium chlorides (ADEBAC), and dialkyl dimethyl ammonium chlorides (DAAC), in combination with an acid source. The sanitizing compositions and methods of using the same provide enhanced sanitizing efficacy at an acidic pH and/or reduced concentration of the antimicrobial quaternary ammonium compound. The compositions can be used as general sanitizing agents or in machine ware washing as a sanitizing rinse aid, including a multipurpose (e.g. 2-in-1) sanitizing rinse aid with surface activity. Sanitizing compositions and methods of employing the same beneficially provide sanitizing efficacy with as low as 20 ppm of the quaternary ammonium compounds against various microorganisms, including Staphylococcus spp. and Escherichia spp. including at low temperatures and an acidic pH.

### CROSS REFERENCE TO RELATED APPLICATIONS

This application is a divisional application of U.S. Ser. No. 17/302,350, filed Apr. 30, 2021, which claims priority under 35 U.S.C. § 119 to provisional application Ser. No. 63/017,961, filed Apr. 30, 2020, both of which are herein incorporated by reference in their entirety.

### FIELD OF THE INVENTION

The invention relates to sanitizing compositions, including sanitizing rinse aid compositions. The compositions include antimicrobial quaternary ammonium compounds, including alkyl dimethyl benzyl ammonium chlorides (ADBAC), alkyl dimethyl ethyl benzyl ammonium chlorides (ADEBAC), and dialkyl dimethyl ammonium chlorides (DAAC), in combination with an acid source providing enhanced sanitizing efficacy at an acidic pH and/or reduced concentration of the antimicrobial quaternary ammonium compound. The compositions can be used as general sanitizing agents or in machine ware washing as a sanitizing rinse aid, including a multipurpose (e.g. 2-in-1) sanitizing rinse aid with surface activity. Sanitizing compositions and methods of employing the same beneficially provide sanitizing efficacy with as low as 20 ppm of the quaternary ammonium compounds against various microorganisms, including Staphylococcus spp. and Escherichia spp. including at low temperatures.

### BACKGROUND OF THE INVENTION

Antimicrobial agents are chemical compositions that are used to prevent microbiological contamination. Antimicrobial agents and compositions are used, for example, as disinfectants or sanitizers in association with hard surface cleaning, food preparation, animal feed, cooling water, hospitality services, hospital and medical uses, pulp and paper manufacturing, cleaning textiles, and water processing. Types of antimicrobial agents, namely sanitizing agents, include commodity chlorine, peroxycarboxylic acids, and quaternary ammonium compounds.

Of the diverse categories of antimicrobial agents and compositions, quaternary ammonium compounds represent one of the largest of the classes of agents in use. It is known that at low concentrations, quaternary ammonium type antimicrobial agents are bacteriostatic, fungistatic, algistatic, sporostatic, and tuberculostatic, whereas at medium concentrations they are bactericidal, fungicidal, algicidal, and viricidal against lipophilic viruses. It is also known that quaternary ammonium compounds have difficulty in retaining kill efficacy against gram negative microbes, such as Escherichia spp. including E. coli, below about 150 ppm and are also inefficient at reduced temperatures and pH. Therefore, it is desirable to boost the antimicrobial activity of a chemical such as a quaternary ammonium compound. It is desirable to boost the antimicrobial activity of such chemicals for us in various applications and provide replacement for commodity chlorine sanitizers.

It is therefore an object of this disclosure to provide sanitizing compositions that can be utilized at a reduced concentration of the antimicrobial quaternary ammonium compound for enhanced antimicrobial efficacy.

It is a further object of this disclosure to provide sanitizing compositions that can be utilized at an acidic pH for enhanced antimicrobial efficacy.

It is a still further object of the disclosure to provide sanitizing compositions efficacious at a low temperature (including below about 120° F.) with the acidic pH and/or reduced concentration of the antimicrobial quaternary ammonium compound.

It is another object of this disclosure to formulate sanitizing compositions that include general sanitizing composition or those for use in machine ware washing as a sanitizing rinse aid, including a multipurpose (e.g. 2-in-1) sanitizing rinse aid with surface activity.

Other objects, aspects and advantages of this invention will be apparent to one skilled in the art in view of the following disclosure, the drawings, and the appended claims.

### SUMMARY OF THE INVENTION

An advantage of the compositions and methods employing antimicrobial quaternary ammonium compounds including alkyl dimethyl benzyl ammonium chlorides (ADBAC), alkyl dimethyl ethyl benzyl ammonium chlorides (ADEBAC), and dialkyl dimethyl ammonium chlorides (DAAC) is that sanitizing efficacy is provided at low temperatures with the acidic pH and/or reduced concentration of the antimicrobial quaternary ammonium compounds. As described, in some embodiments, a pH below about 7, a pH below about 6, or preferably a pH below about 5.5, below about 5, or preferably between about 4-6 or 4-5.5, have superior sanitizing efficacy. Moreover, in some embodiments, the antimicrobial quaternary ammonium compounds can be used at concentrations below about 50 ppm, 40 ppm, 30 ppm, or 20 ppm and provide superior sanitizing efficacy. Still further, in some embodiments, a low concentration of the antimicrobial quaternary ammonium compounds and/or a pH below about 5.5 providing sanitizing efficacy including at least a 5-log (≥99.999%) reduction of microorganisms with at least about 20 ppm, 30 ppm, 40 ppm, or 50 ppm antimicrobial quaternary ammonium compounds. In an embodiment, sanitizing compositions comprise between about 1 wt-% to about 70 wt-% of a quaternary ammonium compound, wherein the quaternary ammonium compound has the formula

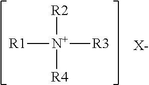

where R1-R4 are alkyl groups each having a chain length between C1-C16 and/or a benzyl or alkylbenzyl group, and X— is an anionic counterion; and between about 1 wt-% to about 90 wt-% of an acid source.

In a further embodiment a method of cleaning a surface comprises: contacting a surface in need of cleaning and/or sanitizing with a composition as described herein; wherein the pH of the use composition is less than about 5.5, or preferably about 5 or less and/or the concentration of the quaternary ammonium compound of at least about 20 ppm or 30 ppm provides at least a 5-log (≥99.999%) reduction of microorganisms on the surface.

In further embodiments, sanitizing rinse aid compositions comprise: between about 1 wt-% to about 50 wt-% of a quaternary ammonium compound, wherein the quaternary ammonium compound has the formula

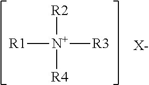

where R1-R4 are alkyl groups each having a chain length between C1-C16 and/or a benzyl or alkylbenzyl group, and X— is an anionic counterion; an acid source; and a defoaming surfactant and/or sheeting agent.

In still further embodiments, a method of cleaning a ware with a sanitizing rinse aid composition comprises: contacting a substrate in a warewash machine with a use solution (or first generating a use solution) of the compositions described herein; wherein the pH of the use composition is less than about 7, and preferably less than or equal to about 5.5 and at a concentration of the quaternary ammonium compound of at least about 20 ppm the composition provides at least a 5-log (≥99.999%) reduction of microorganisms on the surface.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 shows a graph depicting the food contact sanitizing efficacy of didecyl dimethyl ammonium carbonate at varying pH at 120° F. as described in Example 1.

FIG. 2 shows a graph depicting the food contact sanitizing efficacy of didecyl dimethyl ammonium chloride at varying pH at 120° F. as described in Example 1.

FIG. 3 shows a graph with summary of data in Example 1 for food contact sanitizing efficacy at pH 5 for the various evaluated quaternary ammonium compounds.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

The embodiments are not limited to particular sanitizing compositions, which can vary and are understood by skilled artisans. It has been surprisingly found that the antimicrobial quaternary ammonium compounds including alkyl dimethyl benzyl ammonium chlorides (ADBAC), alkyl dimethyl ethyl benzyl ammonium chlorides (ADEBAC), and dialkyl dimethyl ammonium chlorides (DAAC) in combination with an acid to provide a pH below about 7, about 5 or below, or preferably between about 4-6, provide sanitizing efficacy at lower concentrations of the quaternary ammonium compounds. Methods of employing the sanitizing compositions can also vary and are understood by skilled artisans based on the disclosure provided herein.

It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers within the defined range. Throughout this disclosure, various aspects are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments without undue experimentation, but the preferred materials and methods are described herein. In describing and claiming the embodiments, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups), preferably octyl and decyl alkyl groups.

With respect to the quaternary ammonium compounds, the term “alkyl” or “alkyl groups” refers only to saturated hydrocarbons having one or more carbon atoms, including straight-chain alkyl groups (e.g., methyl, ethyl, propyl, butyl, pentyl, hexyl, heptyl, octyl, nonyl, decyl, etc.), preferably octyl and decyl alkyl groups. As described herein, the alkyl groups of the quaternary ammonium compounds preferably include alkyl and dialkyl groups.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

For the purpose of this patent application, successful microbial reduction is achieved when the microbial populations are reduced by at least about 50%, or by significantly more than is achieved by a wash with water. Larger reductions in microbial population provide greater levels of protection.

As used herein, the “cloud point” of a surfactant is defined as the temperature at which a 1 wt. % aqueous solution of the surfactant turns cloudy when warmed.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). As used herein, the term “high level disinfection” or “high level disinfectant” refers to a compound or composition that kills substantially all organisms, except high levels of bacterial spores, and is effected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

As used herein, the term “free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

As used herein, the term “microbe” is synonymous with microorganism. For the purpose of this patent application, successful microbial reduction is achieved when the microbial populations are reduced by at least about 50%, or by significantly more than is achieved by a wash with water. Larger reductions in microbial population provide greater levels of protection. Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can affect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbiocidal and the later, microbiostatic. A sanitizer and a disinfectant are, by definition, agents which provide antimicrobial or microbiocidal activity. In contrast, a preservative is generally described as an inhibitor or microbiostatic composition.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms. According to embodiments of the invention, a sanitizing rinse provides a 99.999% reduction (5-log order reduction) of the desired organisms (including bacterial contaminants) at a use temperature. As a skilled artisan will ascertain from the disclosure herein, the various uses of the sanitizing compositions may employ different testing conditions and temperatures, depending upon the surfaces and applications of use.

The term “surfactant” or “surface active agent” refers to an organic chemical that when added to a liquid, changes the properties of that liquid at a surface.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions may comprise, consist essentially of, or consist of the components and ingredients as well as other ingredients described herein. As used herein, “consisting essentially of” means that the methods and compositions may include additional steps, components, or ingredients, but only if the additional steps, components or ingredients do not materially alter the basic and novel characteristics of the claimed methods and compositions.

### Sanitizing & Rinse Aid Compositions

According to embodiments, the sanitizing compositions include the quaternary ammonium compounds and an acid source. In solid embodiments the sanitizing compositions further include a builder and/or filler. The sanitizing compositions can include additional functional ingredients and can be provided as concentrate or use compositions. Exemplary sanitizing compositions are shown in Tables 1A-1B in weight percentage.

TABLE 1A
(Liquid concentrate formulations)

| | First | Second | Third |
|---|---|---|---|
| | Exemplary | Exemplary | Exemplary |
| Material | Range wt.-% | Range wt.-% | Range wt.-% |
| Quaternary Ammonium | 1-50 | 5-40 | 10-40 |
| Compound | | | |
| Acid | 5-90 | 10-90 | 10-80 |
| Additional Functional | 0-50 | 0-40 | 0-20 |
| Ingredients (including | | | |
| water or solvent) | | | |

TABLE 1B
(Solid formulations)

| | First | Second | Third |
|---|---|---|---|
| | Exemplary | Exemplary | Exemplary |
| Material | Range wt.-% | Range wt.-% | Range wt.-% |
| Quaternary Ammonium | 1-70 | 1-50 | 10-30 |
| Compound | | | |
| Acid | 5-90 | 10-90 | 10-80 |
| Builder/Filler | 1-90 | 5-90 | 10-80 |
| Additional Functional | 0-50 | 0-40 | 0-20 |
| Ingredients | | | |

According to embodiments, the sanitizing rinse aid compositions include the quaternary ammonium compounds, acid source, defoaming surfactant and/or sheeting agent, and water. In solid embodiments the sanitizing rinse aid compositions further include a builder and/or filler. The sanitizing rinse aid compositions can include additional functional ingredients and can be provided as concentrate or use compositions. Exemplary sanitizing compositions are shown in Tables 2A-2B in weight percentage.

TABLE 2A
(Liquid concentrate formulations)

| | First | Second | Third |
|---|---|---|---|
| | Exemplary | Exemplary | Exemplary |
| Material | Range wt.-% | Range wt.-% | Range wt.-% |
| Quaternary Ammonium | 0.5-60 | 1-50 | 10-50 |
| Compound | | | |
| Acid | 0.01-50 | 0.1-50 | 1-50 |
| Defoaming Surfactant | 0.1-40 | 0.5-25 | 0.5-15 |
| Sheeting Agent | 0.01-40 | 0.1-25 | 0.1-15 |
| Additional Functional | 0-50 | 0-40 | 0-20 |
| Ingredients | | | |
| Water | Remainder | Remainder | Remainder |

TABLE 2B
(Solid formulations)

| | First | Second | Third |
|---|---|---|---|
| | Exemplary | Exemplary | Exemplary |
| Material | Range wt.-% | Range wt.-% | Range wt.-% |
| Quaternary Ammonium | 0.5-50 | 1-40 | 1-30 |
| Compound | | | |
| Acid | 1-90 | 5-90 | 10-80 |
| Defoaming Surfactant | 0.1-40 | 0.5-25 | 0.5-15 |
| Sheeting agent | 0.1-40 | 0.5-25 | 0.5-15 |
| Builder/Filler | 1-90 | 5-90 | 10-80 |
| Additional Functional | 0-50 | 0-40 | 0-20 |
| Ingredients | | | |
| Water | 0-10 | 0-10 | 0-5 |

The sanitizing compositions and sanitizing rinse aid compositions set forth in Tables 1-2 have any suitable concentrate or use pH for applications of use, including from about 1 to about 12. However, according to benefits of the sanitizing compositions as described herein, an acidic pH is preferred, including pH<6, <5.5, and <5, and allows for use of a lower concentration (e.g. <50 ppm and as low as 20 ppm or 30 ppm to provide micro efficacy of at least 5 log reduction) of the quaternary ammonium compounds in the composition.

Beneficially, the sanitizing compositions and sanitizing rinse aid compositions are free of oxidizing agents. The compositions can further be free of free of anionic surfactants. In a still further embodiment, the sanitizing compositions and sanitizing rinse aid compositions are free of oxidizing agents and anionic surfactants. Instead, the compositions provide a surfactant-based biocide, namely a quat-based biocide that can include defoaming surfactant and/or sheeting agent.

### Quaternary Ammonium Compound

The sanitizing composition and the sanitizing rinse aid compositions include at least one quaternary ammonium compound with the acid source. Certain quaternary ammonium compounds (“quats”) are known to have antimicrobial activity. Accordingly, various quaternary ammonium compound with antimicrobial activity can be used in the compositions. The term “quaternary ammonium compound” or “quat” generally refers to any composition with the following formula:

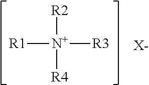

where R1-R4 each have less than a C16 chain length (or C1-C16), wherein the R1-R4 are alkyl groups and/or benzyl or alkylbenzyl groups, and X— is an anionic counterion. In an embodiment the R1-R4 groups may be alike or different, substituted or unsubstituted, saturated or unsaturated, branched or unbranched, and cyclic or acyclic and may contain ether, ester, or amide linkages; they may be aromatic or substituted aromatic groups. The term “anionic counterion” includes any ion that can form a salt with quaternary ammonium. Examples of suitable counterions include halides such as chlorides and bromides, methyl sulfates, carbonates, and bicarbonates. Preferably, the anionic counterion is chloride. In some embodiments quaternary ammoniums have carbon chains between about 1 and 16, between about 8 and 16, preferably between 8 and 12, or more preferably between 8 and 10 are included in compositions. In embodiments the quaternary ammonium compounds have R1-R4 groups with alike or different alkyl chains between about 1 and 16, between about 8 and 16, preferably between 8 and 12, and/or between 8 and 10. In embodiments, the R1-R4 alkyl groups of the quaternary ammonium compound are C1-C4 and C8-C12, such as where two alkyl groups are C1-C4 and two alkyl groups are C8-C12. In further embodiments, the R1-R4 alkyl groups of the quaternary ammonium compound are C1 and C8-C12, such as where two alkyl groups are C1 (dimethyl) and two alkyl groups are C8-C12. In further embodiments at least one of R1-R4 is a benzyl or alkylbenzyl group, wherein the benzyl or alkylbenzyl group is a methyl benzyl or ethylbenzyl.

The quaternary ammonium compounds suitable for the sanitizing applications are water soluble compounds and can further include salts of the compounds described herein. Suitable salts include, for example, salts of both inorganic and organic acids, such as nitrate, sulfate, chloride, bromide, iodide, methyl sulfate, methyl sulfonate, carbonate, bicarbonate, carboxylates, polycarboxylates, phosphates, phosphonates, and the like.

Examples of quaternary ammonium compounds useful in the present invention include but are not limited to alkyl (C8-C16) dimethyl benzyl ammonium chloride (ADBAC), alkyl (C8-16) dimethyl ethyl benzyl ammonium chloride (ADEBAC), didecyl dimethyl ammonium carbonate/bicarbonate and dialkyl (C8-C16) dimethyl ammonium chloride (DAAC), including octyl decyl dimethyl ammonium chloride, dioctyl dimethyl ammonium chloride, and didecyl dimethyl ammonium chloride. In preferred embodiments, the dialkyl dimethyl ammonium chloride (DAAC) is a dialkyl having C10 or less (C8-C10). In a preferred embodiment, the quaternary ammonium compound is a blend of octyl decyl dimethyl, dioctyl dimethyl, and didecyl dimethyl ammonium chloride. A single quaternary ammonium or a combination of more than one quaternary ammonium may be included in compositions.

In some embodiments depending on the nature of the R group, the anion, and the number of quaternary nitrogen atoms present, the antimicrobial quaternary ammonium compounds may be classified into one of the following categories: monoalkyltrimethyl ammonium salts; alkylmethylbenzyl ammonium salts; monoalkyldimethylbenzyl ammonium salts; dialkyldimethyl ammonium salts; heteroaromatic ammonium salts; polysubstituted quaternary ammonium salts; bis-quaternary ammonium salts; and polymeric quaternary ammonium salts. Each category will be discussed herein.

Monoalkyltrimethyl ammonium salts contain one R group that is a long-chain alkyl group, and the remaining R groups are short-chain alkyl groups, such as methyl or ethyl groups. Some non-limiting examples of monoalkyltrimethyl ammonium salts include cetyltrimethylammonium bromide, commercially available under the tradenames Rhodaquat M242C/29 and Dehyquart A; alkyltrimethyl ammonium chloride, commercially available as Arquad 16; alkylaryltrimethyl ammonium chloride; and cetyldimethyl ethylammonium bromide, commercially available as Ammonyx DME.

Monoalkyldimethylbenzyl ammonium salts contain one R group that is a long-chain alkyl group, a second R group that is a benzyl or alkylbenzyl group, and the two remaining R groups are short-chain alkyl groups, such as methyl or ethyl groups. Monoalkyldimethylbenzyl ammonium salts are generally compatible with nonionic surfactants, detergent builders, perfumes, and other ingredients. Some non-limiting examples of monoalkyldimethylbenzyl ammonium salts include alkyldimethylbenzyl ammonium chlorides, commercially available as Barquat from Lonza Inc.; and benzethonium chloride, commercially available as Lonzagard, from Lonza Inc. Additionally, the monoalkyldimethylbenzyl ammonium salts may be substituted. Non-limiting examples of such salts include dodecyldimethyl-3,4-dichlorobenzyl ammonium chloride. Finally, there are mixtures of alkyldimethylbenzyl and alkyldimethyl substituted benzyl (ethylbenzyl) ammonium chlorides commercially available as BTC 2125M from Stepan Company, and Barquat 4250 from Lonza Inc.

Dialkyldimethyl ammonium salts contain two R groups that are long-chain alkyl groups, and the remaining R groups are short-chain alkyl groups, such as methyl groups. Some non-limiting examples of dialkyldimethyl ammonium salts include didecyldimethyl ammonium halides, commercially available as Bardac 22 from Lonza Inc.; didecyl dimethyl ammonium chloride commercially available as Bardac 2250 from Lonza Inc.; dioctyl dimethyl ammonium chloride, commercially available as Bardac LF and Bardac LF-80 from Lonza Inc.); and octyl decyl dimethyl ammonium chloride sold as a mixture with didecyl and dioctyl dimethyl ammonium chlorides, commercially available as Bardac 2050 and 2080 from Lonza Inc.

In liquid sanitizing composition embodiments, the quaternary ammonium compound is included in the sanitizing composition at an amount of at least about 1 wt-% to about 50 wt-%, about 5 wt-% to about 50 wt-%, about 5 wt-% to about 40 wt-%, about 10 wt-% to about 40 wt-%, or about 10 wt-% to about 20 wt-%. In other embodiments the quaternary ammonium compound is included in the sanitizing composition at an amount of at least about 1 wt-% to about 20 wt-%. In solid sanitizing composition embodiments, the quaternary ammonium compound is included in the sanitizing composition at an amount of at least about 1 wt-% to about 70 wt-%, about 1 wt-% to about 60 wt-%, about 1 wt-% to about 50 wt-%, about 1 wt-% to about 40 wt-%, about 1 wt-% to about 30 wt-%, or about 10 wt-% to about 30 wt-%. In other embodiments the quaternary ammonium compound is included in the sanitizing composition at an amount of at least about 1 wt-% to about 20 wt-%. In addition, without being limited according to the invention, all ranges recited are inclusive of the numbers defining the range and include each integer within the defined range.

In liquid sanitizing rinse aid composition embodiments, the quaternary ammonium compound is included in the composition at an amount of at least about 0.5 wt-% to about 60 wt-%, about 1 wt-% to about 60 wt-%, about 1 wt-% to about 50 wt-%, about 5 wt-% to about 50 wt-%, or about 10 wt-% to about 50 wt-%. In other embodiments the quaternary ammonium compound is included in the sanitizing rinse aid composition at an amount of at least about 0.5 wt-% to about 20 wt-%. In solid sanitizing rinse aid composition embodiments, the quaternary ammonium compound is included in the composition at an amount of at least about 0.5 wt-% to about 50 wt-%, 1 wt-% to about 40 wt-%, about 1 wt-% to about 35 wt-%, about 1 wt-% to about 30 wt-%, or about 5 wt-% to about 30 wt-%. In other embodiments the quaternary ammonium compound is included in the sanitizing rinse aid composition at an amount of at least about 0.5 wt-% to about 20 wt-%. In addition, without being limited according to the invention, all ranges recited are inclusive of the numbers defining the range and include each integer within the defined range.

### Acid Source

The sanitizing composition and the sanitizing rinse aid compositions include at least one acid source with the quaternary ammonium compound. The acid forms a concentrate composition or a use solution with a desired acidic to neutral pH. The acid can be effective to form a use composition with pH of about 7, about 6 or less, about 5 or less, about 4, about 4 or less, about 3, about 3 or less, about 2, about 2 or less, or the like.

In an embodiment, the acid is an organic acid. Suitable organic acids include, but are not limited to, methane sulfonic acid, ethane sulfonic acid, propane sulfonic acid, butane sulfonic acid, xylene sulfonic acid, benzene sulfonic acid, and mono, di, or tri-carboxylic acids, picolinic acid, dipicolinic acid, and mixtures thereof. In a preferred embodiment the acid is a carboxylic acid or polycarboxylic acid, or salt thereof. In a further preferred embodiment the acid is lactic acid or citric acid. Beneficially, the acid component can further aid with defoaming of the sanitizing compositions and does not negatively interfere with the microbial efficacy of the quaternary ammonium compound.

In liquid sanitizing composition embodiments, the acid source is included in the sanitizing composition at an amount of at least about 1 wt-% to about 90 wt-%, about 5 wt-% to about 90 wt-%, about 10 wt-% to about 90 wt-%, or about 10 wt-% to about 80 wt-%. In other embodiments the acid source is included in the sanitizing composition at an amount of at least about 1 wt-% to about 50 wt-%. In solid sanitizing composition embodiments, the acid source is included in the sanitizing composition at an amount of at least about 1 wt-% to about 90 wt-%, 5 wt-% to about 90 wt-%, about 10 wt-% to about 90 wt-%, or about 10 wt-% to about 80 wt-%. In other embodiments the acid source is included in the sanitizing composition at an amount of at least about 1 wt-% to about 50 wt-%. In addition, without being limited according to the invention, all ranges recited are inclusive of the numbers defining the range and include each integer within the defined range.

In liquid sanitizing rinse aid composition embodiments, the acid source is included in the composition at an amount of at least about 0.01 wt-% to about 60 wt-%, about 0.01 wt-% to about 50 wt-%, about 0.1 wt-% to about 50 wt-%, or about 1 wt-% to about 50 wt-%. In other embodiments the acid source is included in the sanitizing rinse aid composition at an amount of at least about 0.01 wt-% to about 50 wt-%. In solid sanitizing rinse aid composition embodiments, the acid source is included in the composition at an amount of at least about 1 wt-% to about 90 wt-%, 5 wt-% to about 90 wt-%, about 10 wt-% to about 90 wt-%, or about 10 wt-% to about 80 wt-%. In other embodiments the acid source is included in the sanitizing rinse aid composition at an amount of at least about 0.01 wt-% to about 50 wt-%. In addition, without being limited according to the invention, all ranges recited are inclusive of the numbers defining the range and include each integer within the defined range.

### Defoaming Surfactant

The sanitizing rinse aid compositions include at least one defoaming surfactant and/or sheeting agent in addition to the acid source and quaternary ammonium compound. Defoaming surfactants are useful for reducing the stability of foam that may be created by the quaternary ammonium compound(s) and/or sheeting agent in an aqueous solution. Defoaming surfactants preferably include nonionic surfactants including alcohol alkoxylates, alkyl capped PO surfactants and EO/PO copolymers and block copolymers. In an embodiment the defoaming surfactant is an alkyl capped PO surfactant with a cloud point below room temperature. In some embodiments, the defoaming surfactants can be food grade quality given the applications of use as rinse aid compositions. In some embodiments an antifoaming agent could be used in addition to the defoaming surfactant or in place thereof.

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties. Useful nonionic surfactants include:

Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available under the trade names Pluronic® and Tetronic® manufactured by BASF Corp. Pluronic® compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Tetronic® compounds are tetra-functional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhodia and Triton® manufactured by Dow Chemical Company.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Neodol® manufactured by Shell Chemical Co. and Alfonic® manufactured by Sasol North America Inc.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Examples of nonionic low foaming surfactants include: compounds which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics® are manufactured by BASF Corporation under the trade name Pluronic® R surfactants. Likewise, the Tetronic®R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

Compounds described herein can also be modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959 to Brown et al. and represented by the formula

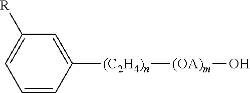

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkaline oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R₁ is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

The ethoxylated C6-C18 fatty alcohols and C6-C18 mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

A useful class of non-ionic surfactants include the class defined as alkoxylated amines or, most particularly, alcohol alkoxylated/aminated/alkoxylated surfactants. These non-ionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic® PEA 25 Amine Alkoxylate. Preferred nonionic surfactants for the compositions of the invention include alcohol alkoxylates, EO/PO block copolymers, alkylphenol alkoxylates, and the like.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present invention. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

In addition to defoaming surfactants, antifoaming agents includes silicones. Silicones such as dimethyl silicone, glycol polysiloxane, methylphenol polysiloxane, trialkyl or tetralkyl silanes, hydrophobic silica defoamers and mixtures thereof can all be used in defoaming applications. Commercial defoamers commonly available include silicones such as Ardefoam® from Armour Industrial Chemical Company which is a silicone bound in an organic emulsion; Foam Kill® or Kresseo® available from Krusable Chemical Company which are silicone and non-silicone type defoamers as well as silicone esters; and Anti-Foam A® and DC-200 from Dow Corning Corporation which are both food grade type silicones among others.

In liquid sanitizing rinse aid composition embodiments with a defoaming surfactant, the defoaming surfactant is included in the composition at an amount of at least about 0.01 wt-% to about 40 wt-%, about 0.01 wt-% to about 40 wt-%, about 0.5 wt-% to about 25 wt-%, or about 0.5 wt-% to about 15 wt-%. In solid sanitizing rinse aid composition embodiments with a defoaming surfactant, the defoaming surfactant is included in the composition at an amount of at least about 0.01 wt-% to about 40 wt-%, about 0.01 wt-% to about 40 wt-%, about 0.5 wt-% to about 25 wt-%, or about 0.5 wt-% to about 15 wt-%. In addition, without being limited according to the invention, all ranges recited are inclusive of the numbers defining the range and include each integer within the defined range.

### Sheeting Agent

The sanitizing rinse aid compositions include at least one sheeting agent and/or defoaming surfactant in addition to the acid source and quaternary ammonium compound.

The alcohol ethoxylate compounds that include an alkyl group that has 12 or fewer carbon atoms have the structure represented by Formula I: R—O—(CH₂CH₂O)ₙ—H (I) wherein R is a (C₁-C₁₂) alkyl group and n is an integer in the range of 1 to 100. In some embodiments, R may be a (C₈-C₁₂) alkyl group, or may be a (C₈-C₁₀) alkyl group. Similarly, in some embodiments, n is an integer in the range of 10-50, or in the range of 15-30, or in the range of 20-25. In some embodiments, alcohol ethoxylate has a low EO content, such as n of 6 or less.

In at least some embodiments, the sheeting agent includes at least two different alcohol ethoxylate compounds each having structure represented by Formula I. That is, the R and/or n variables of Formula I, or both, may be different in the two or more different alcohol ethoxylate compounds present in the sheeting agent. For example, the sheeting agent in some embodiments may include a first alcohol ethoxylate compound in which R is a (C₈-C₁₀) alkyl group, and a second alcohol ethoxylate compound in which R is a (C₁₀-C₁₂) alkyl group. In at least some embodiments, the sheeting agent does not include any alcohol ethoxylate compounds that include an alkyl group that has more than 12 carbon atoms. In some embodiments, the sheeting agent includes only alcohol ethoxylate compounds that include an alkyl group that has 12 or fewer carbon atoms.

In some embodiments, the alcohol ethoxylates used in the sheeting agent can be chosen such that they have certain characteristics, for example, are environmentally friendly, are suitable for use in food service industries, and/or the like. For example, the particular alcohol ethoxylates used in the sheeting agent may meet environmental or food service regulatory requirements, for example, biodegradability requirements.

In liquid and/or solid sanitizing rinse aid composition embodiments with a sheeting agent, the sheeting agent is included in the composition at an amount of at least about 0.01 wt-% to about 40 wt-%, about 0.1 wt-% to about 40 wt-%, about 0.1 wt-% to about 25 wt-%, or about 0.1 wt-% to about 15 wt-%. In addition, without being limited according to the invention, all ranges recited are inclusive of the numbers defining the range and include each integer within the defined range.

Builder and/or Filler

The solid embodiments of the sanitizing compositions and the sanitizing rinse aid compositions include at least one builder and/or filler. Exemplary agents can include sodium sulfate, sodium chloride, magnesium sulfate, starches, sugars, C₁-C₁₀ alkylene glycols such as propylene glycol and the like. Further exemplary agents can include solid PEG, solid PPG, solid EP/PO, amides, urea, salts, such as phosphates, sulfates, acetates, borates or silicates, and the like.

In solid sanitizing composition embodiments, the builder(s) and/or filler(s) is/are included in the sanitizing composition at an amount of at least about 1 wt-% to about 90 wt-%, 5 wt-% to about 90 wt-%, about 10 wt-% to about 90 wt-%, or about 10 wt-% to about 80 wt-%. In solid sanitizing rinse aid composition embodiments, the builder(s) and/or filler(s) is/are included in the composition at an amount of at least about 1 wt-% to about 90 wt-%, 5 wt-% to about 90 wt-%, about 10 wt-% to about 90 wt-%, or about 10 wt-% to about 80 wt-%. In addition, without being limited according to the invention, all ranges recited are inclusive of the numbers defining the range and include each integer within the defined range.

### Additional Functional Ingredients

The components of the sanitizing compositions and/or sanitizing rinse aid compositions can further be combined with various functional components suitable for uses disclosed herein. In some embodiments, the compositions including the acid and quaternary ammonium compounds make up a large amount, or even substantially all of the total weight of the compositions. For example, in some embodiments few or no additional functional ingredients are disposed therein.

In other embodiments, additional functional ingredients may be included in the sanitizing compositions and/or sanitizing rinse aid compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the compositions may include additional functional ingredients including, for example, additional surfactants, thickeners and/or viscosity modifiers, solvents, solubility modifiers, humectants, metal protecting agents, stabilizing agents, e.g., chelating agents or sequestrants, corrosion inhibitors, sequestrants and/or chelating agents, solidifying agent, sheeting agents, pH modifying components, including alkalinity and/or acidity sources, aesthetic enhancing agents (i.e., colorants, odorants, or perfumes), other cleaning agents, hydrotropes or couplers, buffers, and the like. Additionally, the compositions can be used in conjunction with one or more conventional cleaning agents.

In liquid sanitizing composition embodiments, the additional functional ingredient(s) is included in the sanitizing composition at an amount of at least about 0 wt-% to about 50 wt-%, about 0 wt-% to about 40 wt-%, or about 0 wt-% to about 20 wt-%. In solid sanitizing composition embodiments, the additional functional ingredient(s) is included in the sanitizing composition at an amount of at least about 0 wt-% to about 50 wt-%, about 0 wt-% to about 40 wt-%, or about 0 wt-% to about 20 wt-%. In addition, without being limited according to the invention, all ranges recited are inclusive of the numbers defining the range and include each integer within the defined range.

In liquid sanitizing rinse aid composition embodiments, the additional functional ingredient(s) is included in the sanitizing composition at an amount of at least about 0 wt-% to about 50 wt-%, about 0 wt-% to about 40 wt-%, or about 0 wt-% to about 20 wt-%. In solid sanitizing rinse aid composition embodiments, the additional functional ingredient(s) is included in the sanitizing composition at an amount of at least about 0 wt-% to about 50 wt-%, about 0 wt-% to about 40 wt-%, or about 0 wt-% to about 20 wt-%. In addition, without being limited according to the invention, all ranges recited are inclusive of the numbers defining the range and include each integer within the defined range.

### Exemplary Compositions

The sanitizing compositions may include concentrate compositions and use compositions, or may be diluted to form use compositions. For example, a concentrate composition can be diluted, for example with water, to form a use composition. In general, a concentrate refers to a composition that is intended to be diluted, such as with water to provide a use solution that contacts a surface and/or product in need of treatment to provide the desired surface activity. The sanitizing compositions that contact the surface and/or product in need of treatment can be referred to as a concentrate or a use composition (or use solution) dependent upon the formulation employed in methods as described herein. It should be understood that the concentration of the quaternary ammonium compound in the composition will vary depending on whether the composition is provided as a concentrate or as a use solution. In an embodiment, a concentrate composition can be diluted to a use solution before applying to an object. The concentrate can be marketed and an end user can dilute the concentrate with water or an aqueous diluent to a use solution.

Compositions can be formulated and sold for use as is, or as concentrates. If desired, such concentrates can be used full-strength as sanitizing compositions. However, the concentrates typically will be diluted with a fluid (e.g., water) that subsequently forms the dilute phase or a use solution. Preferably, the concentrate forms a single phase before such dilution and remains so while stored in the container in which it will be sold. When combined with water or other desired diluting fluid at an appropriate dilution level and subjected to mild agitation (e.g., by stirring or pumping the composition), some compositions of the invention will form a pseudo-stable dispersion, and other compositions of the invention will form a clear or quasi-stable solution or dispersion. If a pseudo-stable composition is formed, then the composition preferably remains in the pseudo-stable state for a sufficiently long period so that the composition can be applied to a surface before the onset of phase separation. The pseudo-stable state need only last for a few seconds when suitably rapid application techniques such as spraying are employed, or when agitation during application is employed. The pseudo-stable state desirably lasts for at least one minute or more after mixing and while the composition is stored in a suitable vessel, and preferably lasts for five minutes or more after mixing. Often normal refilling or replenishment of the applicator (e.g., by dipping the applicator in the composition) will provide sufficient agitation to preserve the pseudo-stable state of the composition during application.

A use solution may be prepared from the concentrate by diluting the concentrate with water at a dilution ratio that provides a use solution having desired sanitizing and/or other antimicrobial properties. The water that is used to dilute the concentrate to form the use composition can be referred to as water of dilution or a diluent, and can vary from one location to another. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water. Particularly, the concentrate is diluted at a ratio of between about 1:100 and about 1:5,000 concentrate to water. More particularly, the concentrate is diluted at a ratio of between about 1:250 and about 1:2,000 concentrate to water.

In an embodiment, a concentrate composition can be diluted to a use solution before applying to an object. The concentrate can be marketed and an end user can dilute the concentrate with water or an aqueous diluent to a use solution. The level of active components in the concentrate composition is dependent on the intended dilution factor and the desired activity of the antimicrobial composition. Generally, a dilution of about 1 fluid ounce to about 10 gallons of water to about 10 fluid ounces to about 1 gallon of water is used for aqueous compositions of the present invention. In some embodiments, higher use dilutions can be employed if elevated use temperature (greater than 25° C.) or extended exposure time (greater than 30 seconds) can be employed. In the typical use locus, the concentrate is diluted with a major proportion of water using commonly available tap or service water mixing the materials at a dilution ratio of about 3 to about 40 ounces of concentrate per 100 gallons of water.

In some embodiments, the concentrated compositions can be diluted at a dilution ratio of about 0.1 g/L to about 100 g/L concentrate to diluent, about 0.5 g/L to about 10.0 g/L concentrate to diluent, about 1.0 g/L to about 4.0 g/L concentrate to diluent, or about 1.0 g/L to about 2.0 g/L concentrate to diluent.

In other embodiments, a use composition can include about 0.01 to about 10 wt-% of a concentrate composition and about 90 to about 99.99 wt-% diluent; or about 0.1 to about 1 wt-% of a concentrate composition and about 99 to about 99.9 wt-% diluent.

Amounts of an ingredient in a use composition can be calculated from the amounts listed above for concentrate compositions and these dilution factors. In some embodiments, the concentrated compositions of the present invention are diluted such that the quaternary ammonium component is present at from about 1 ppm to about 100 ppm, or preferably about 1 ppm to about 50 ppm.

In an embodiment of the invention, the concentrated compositions and use compositions maintain their sanitizing efficacy while being tolerant to water conditions, or are independent of water conditions such as water hardness. According to embodiments of the invention, compositions are tolerant of water conditions of about 0 parts per million (ppm) to about 500 ppm (about 0 to about 30 grains per gallon) water hardness without impacting sanitizing efficacy according to embodiments described herein. As referred to herein, the ppm of water hardness refers to ppm of calcium, magnesium and other metals which may be found in the water and contributing to the hardness level.

### Methods of Use

The compositions can be employed in various sanitizing applications. Beneficially, the compositions are non-corrosive and low odor, in addition to providing microbial efficacy for the various sanitizing applications described herein. In some embodiments, the sanitizing compositions are useful for various consumer and institutional hard surface sanitizing applications, including for example, food contact and non-food contact sanitizing applications on hard surfaces. Hard surface sanitizing applications are useful for various food and beverage applications, health care, hospitality, and other applications requiring hard surface sanitizing. Hard surfaces include, for example, glass, plastic, ceramic, melamine, stainless steel, etc. The various food contact and non-food contact sanitizing applications can include a no-rinse cleaner.

The compositions can further be employed in sanitizing applications for containers, processing facilities, or equipment in the food service or food processing industries. The compositions have particular value for use on food packaging materials and equipment, including for cold or hot aseptic packaging. Examples of process facilities in which the compositions can be employed include a milk line dairy, a continuous brewing system, food processing lines such as pumpable food systems and beverage lines, ware wash machines, low temperature ware wash machines, dishware, bottle washers, bottle chillers, warmers, third sink washers (e.g. first compartment detergent solution, second compartment rinse/hot clean water, third compartment sanitizing), processing equipment such as tanks, vats, lines, pumps and hoses, and transportation vehicles. The compositions can be used to sanitize tanks, lines, pumps, and other equipment used for the manufacture and storage of soft drink materials, and also used in the bottling or containers for the beverages.

The sanitizing rinse aid compositions can be employed in various machine warewash applications. The sanitizing rinse aid compositions can be employed as a replacement for conventional chlorine sanitizers and/or peroxycarboxylic acid sanitizers. Such conventional sanitizing steps in machine warewashing are shown for example in Table 3 as an exemplary listing of conventional sanitizing processes.

TABLE 3

| | Multipurpose (e.g. 2-in-1) |
|---|---|
| 3 Part Ware washing | Ware washing (Liquid) |
| 1) Detergent | 1) Detergent |
| 2) Rinse Aid | 2 + 3) Peracid Sanitizing Rinse Aid |
| 3) Chlorine Sanitizer | |

Beneficially, the sanitizing rinse aid compositions described herein can be replacements for such chlorine sanitizers and/or peroxycarboxylic acid sanitizers, as shown for example in Table 4. In an embodiment, the sanitizing rinse aid composition is combined with a rinse aid composition as a three-part process. Beneficially, in other embodiments, the sanitizing rinse aid composition is provided as a multipurpose (e.g. 2-in-1) composition providing the sanitizing and sheeting/rinse aid in a single step.

TABLE 4

| | Multipurpose (e.g. 2-in-1) Ware |
|---|---|
| 3 Part Ware washing | washing (Liquid or Solid) |
| 1) Detergent | 1) Detergent |
| 2) Rinse Aid | 2 + 3) Sanitizing rinse aid |
| 3) Sanitizing rinse aid | |

In some aspects, the methods for rinsing ware in a warewashing application using the sanitizing rinse aid composition include contacting a selected substrate with the composition. The composition can be dispensed as a concentrate or as a use solution. In addition, the composition concentrate can be provided in a solid form or in a liquid form. In general, it is expected that the concentrate will be diluted with water to provide the use solution that is then supplied to the surface of a substrate. The use solution can be applied to the substrate during a rinse application, for example, during a rinse cycle, for example, in a warewashing machine. In some embodiments, formation of a use solution can occur from a rinse agent installed in a cleaning machine, for example onto a dish rack. The composition can be diluted and dispensed from a dispenser mounted on or in the machine or from a separate dispenser that is mounted separately but cooperatively with the dish machine.

In some embodiments, liquid composition can be dispensed by incorporating compatible packaging containing the liquid material into a dispenser adapted to diluting the liquid with water to a final use concentration. Some examples of dispensers for the liquid rinse agent of the invention are DRYMASTER-P sold by Ecolab Inc., St. Paul, Minn.

In other exemplary embodiments, solid products, such as pressed, cast or extruded solid compositions, may be dispensed by inserting a solid material in a container or with no enclosure into a spray-type dispenser such as the volume SOL-ET controlled ECOTEMP Rinse Injection Cylinder system manufactured by Ecolab Inc., St. Paul, Minn. Such a dispenser cooperates with a warewashing machine in the rinse cycle. When demanded by the machine, the dispenser directs a spray of water onto the cast solid block of rinse agent which effectively dissolves a portion of the block creating a concentrated aqueous rinse solution which is then fed directly into the rinse water forming the aqueous rinse. The aqueous rinse is then contacted with the dishes to affect a complete rinse. This dispenser and other similar dispensers are capable of controlling the effective concentration of the active portion in the aqueous rinse by measuring the volume of material dispensed, the actual concentration of the material in the rinse water (an electrolyte measured with an electrode) or by measuring the time of the spray on the cast block.

The compositions can be employed as a sanitizing rinse aid in any type of warewashing machines. As discussed above, there are two general types of rinse cycles in commercial warewashing machines. A first type of rinse cycle can be referred to as a hot water sanitizing rinse cycle because of the use of generally hot rinse water (about 180° F.). A second type of rinse cycle can be referred to as a chemical sanitizing rinse cycle and it uses generally lower temperature rinse water (about 120° F.). Beneficially, the sanitizing rinse aid compositions perform unexpectedly well at low temperatures.

Exemplary substrates in the warewashing industry that can be treated with a rinse aid according to the invention include plastics, dishware, cups, glasses, flatware, and cookware. For the purposes of this invention, the terms “dish” and “ware” are used in the broadest sense to refer to various types of articles used in the preparation, serving, consumption, and disposal of food stuffs including pots, pans, trays, pitchers, bowls, plates, saucers, cups, glasses, forks, knives, spoons, spatulas, and other glass, metal, ceramic, plastic composite articles commonly available in the institutional or household kitchen or dining room. In general, these types of articles can be referred to as food or beverage contacting articles because they have surfaces which are provided for contacting food and/or beverage. When used in these warewashing applications, the composition should provide effective sheeting action and low foaming properties. In addition to having the desirable properties described above, it may also be useful for the composition to be biodegradable, environmentally friendly, and generally nontoxic. A rinse aid of this type may be described as being “food grade”.

Both the sanitizing compositions and rinse aid compositions can be applied at a use or concentrate solution pH between about 0 to about 12. However, the benefits of using a lower concentration of the quaternary ammonium compound are best achieved for the sanitizing efficacy at a use solution pH between about 1 and about 7, between about 1 and about 6, and most preferably between about 1 and about 5.5, between about 1 and about 5, or between about 1 and about 4. In another embodiment the use solution pH of the composition is between about 2 and about 5.5, between about 2 and about 5, or between about 2 and about 4. Without limiting the scope of invention, the numeric ranges are inclusive of the numbers defining the range and include each integer within the defined range.

The sanitizing compositions are in contact with a surface or object for a sufficient amount of time to clean the surface or object. In an aspect, the surface or object is contacted with the sanitizing composition for at least a few seconds, at least about 15 seconds, at least about 30 seconds, or at least about 1 minute.

The sanitizing compositions can be applied as a use or concentrate solution to a surface or object in need of cleaning. In an aspect, a use concentration of the sanitizing composition includes from about 1 ppm to about 100 ppm, including all ranges there between. As one skilled in the art will recognize there is a benefit to use of lower concentrations of the compounds, namely below about 60 ppm, below about 50 ppm, below about 40 ppm, or even below about 30 ppm, however greater concentrations will provide efficacy as well. Beneficially, in various applications of use a lower concentration of the quaternary ammonium compound when provided in combination with the acid to provide the preferred acidic pHs and provides unexpected antimicrobial efficacy against a broad spectrum of microbes.

Suitable concentrations of the quaternary ammonium compound which provide the antimicrobial efficacy at the lower concentrations due to the acidic pH in the use solutions include at least from about 1 to about 50 ppm, from about 1 to about 45 ppm, from about 1 to about 40 ppm, from about 1 to about 35 ppm, or from about 1 to about 30 ppm, or any ranges therein. In preferred embodiments, concentrations of the quaternary ammonium compound in such a use solution include at least from about 20 to about 50 ppm, from about 20 to about 40 ppm, from about 20 to about 30 ppm, or any ranges therein. In some aspects, the sanitizing compositions beneficially provide efficacy against gram negative microbes which conventionally require more than 150 ppm quaternary ammonium compounds for any antimicrobial efficacy. Without being limited to a particular mechanism of action, the low actives of the quaternary ammonium compound is a result of the quaternary ammonium compound structure and combination with the acid to provide an acidic pH providing synergistic efficacy.

The methods of use can be employed at a broad temperature range, including both low temperature (including below about 120° F.) or at temperatures in excess of about 120° F. It is a benefit to the methods of using the sanitizing compositions and the sanitizing rinse aid compositions that the combination of the acidic pH use solution pH to enable reduced concentration of the antimicrobial quaternary ammonium compounds can be employed at varying temperature ranges depending upon the selected use solution pH and antimicrobial quaternary ammonium compounds concentrations. For example, in an embodiment, wherein the pH of the use composition is ≤7 and the use solution of the composition provides a quaternary ammonium compound concentration in a lower range of from about 20 ppm to about 50 ppm a temperature of at least about 120° F. may be employed to provide the desired sanitizing efficacy of at least a 5-log (≥99.999%) reduction of microorganisms. In embodiments, wherein the pH of the use composition is ≤7 and the use solution of the composition provides a quaternary ammonium compound concentration in a higher range of at least about 50 ppm a temperature of less than about 120° F. may be employed to provide the desired sanitizing efficacy of at least a 5-log (≥99.999%) reduction of microorganisms.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The following quaternary ammonium compounds and polymer/surfactants were evaluated in the Examples:
Bardac 2250: 50% didecyl dimethyl ammonium chloride, available from Lonza.
Bardac 205M: blend of 20% alkyl (C₁₄ 50%, C₁₂ 40%, C₁₆ 10%) dimethyl benzyl ammonium chloride, 15% octyl decyl dimethyl ammonium chloride, 6% dioctyl dimethyl ammonium chloride, 9% didecyl dimethyl ammonium chloride available from Lonza.
Bardac 2080: blend of 25% octyl decyl dimethyl ammonium chloride, 10% dioctyl dimethyl ammonium chloride, 15% didecyl dimethyl ammonium chloride, available from Lonza.
Bardac LF: 50% dioctyl dimethyl ammonium chloride, available from Lonza.
CarboQuat: 50% didecyl dimethyl ammonium carbonate/bicarbonate, available from Lonza.
Quat: didecyl dimethyl ammonium methyl sulfonate/sulfate (a proprietary experimental quat).
Barquat MB 50: blend of 50% alkyl (C₁₄ 50%, C₁₂ 40%, C₁₆ 10%) dimethyl benzyl ammonium chloride, available from Lonza.
Plurafac SLF180: fatty alcohol alkoxylate nonionic surfactant available from BASF.
Polypropylene glycol (PPG2000): polymer with molecular weight average of 2000 available from Alfa Aesar.
Pluronic L61: EO/PO block copolymer nonionic surfactant available from BASF.
Lutensol TDA3: tridecyl ethoxylated alcohol nonionic surfactant available from BASF.
Surfonic L24-3: ethoxylated linear, primary C12-C14 alcohol nonionic surfactant available from Huntsman.
Tomadol 91-2.5: ethoxylated alcohol nonionic surfactant available from Evonik.
Pluronic 31R₁: EO/PO block copolymer nonionic surfactant available from BASF.

### Example 1

The microbial efficacy of the multipurpose sanitizing composition was evaluated for food contact applications. The purpose of the testing is to determine the efficacy of compositions used for sanitizing food contact surfaces, which in the evaluations were pre-cleaned, non-porous surfaces using AOAC Method 960.09 Germicidal and Detergent Sanitizing Action of Disinfectants. The test entails a suspension test wherein 1 part test suspension is added to 99 parts sanitizer composition using 500 ppm hard water at 120° F. The test organisms included Staphylococcus aureus ATCC 6538 and Escherichia coli ATCC 11229. To determine efficacy the sanitizing composition is required to demonstrate greater than or equal to a 5-log (≥99.999%) reduction of tested organisms with a 30 second exposure time.

Table 5 shows the testing of various quaternary ammonium compounds at pHs between 9 and 3 to demonstrate the effect of pH on the antimicrobial efficacy of the quaternary ammonium compounds. The pH was adjusted by use of a polycarboxylic acid (unless otherwise noted, such as the polycarboxylate citrate tested at pH 8). In this screening test pH 9, 8, 7, 5, 4, and 3 were tested. “NT” indicates a condition was “Not Tested.”

TABLE 5

| | E. coli | S. aureus |
|---|---|---|
| | (ATCC 11229) | (ATCC 6538) |
| pH 9 | | |
| 50 ppm Bardac 205M | 3.39 | 6.80 |
| 40 ppm Bardac 2250 | 4.63 | NT |
| 30 ppm Bardac 2250 | 3.33 | NT |
| pH 8 | | |
| 40 ppm CarboQuat | 5.70 | 6.69 |
| 30 ppm CarboQuat | 3.21 | 6.69 |
| 30 ppm CarboQuat: citrate | 3.20 | NT |
| pH 7 | | |
| 50 ppm Bardac 2250 | 6.71 | NT |
| 40 ppm Bardac 2250 | 5.02 | NT |
| 30 ppm Bardac 2250 | 3.33 | NT |
| 40 ppm Bardac 2250, 40 | 3.17 | NT |
| ppm SLF180 | | |
| 40 ppm Bardac 2250, 20 | 4.07 | NT |
| ppm SLF180, 20 ppm | | |
| PPG2000 | | |
| 90 ppm Bardac LF | 3.06 | NT |
| 60 ppm Bardac LF | 3.06 | NT |
| 30 ppm Bardac LF | 3.06 | NT |
| 30 ppm Bardac LF, 30 ppm | 3.05 | NT |
| SLF180 | | |
| 30 ppm Bardac LF, 30 ppm | 3.05 | NT |
| TDA3 | | |
| 30 ppm Bardac LF, 30 ppm | 3.05 | NT |
| Surfonic 24-3 | | |
| 30 ppm Bardac LF, 30 ppm | 3.05 | NT |
| Tomadol 91-2.5 | | |
| pH 5 | | |
| 30 ppm Quat | 4.93 | 6.69 |
| 30 ppm CarboQuat | 6.68 | 6.69 |
| 30 ppm CarboQuat | 6.33 | 6.88 |
| 30 ppm CarboQuat | 6.51 | NT |
| 30 ppm CarboQuat: citric | 6.67 | NT |
| acid | | |
| 30 ppm CarboQuat: formic | 6.67 | NT |
| acid | | |
| 20 ppm CarboQuat | 5.08 | 6.88 |
| 30 ppm BarQuat MB-50 | 4.41 | 6.88 |
| 30 ppm Bardac 2250 | 6.83 | 6.88 |
| 30 ppm Bardac 2250, 10 | 6.79 | NT |
| ppm SLF180, 30 pm | | |
| PPG2000 | | |
| 30 ppm Bardac 2250, 30 | 6.79 | NT |
| ppm PPG2000 | | |
| 30 ppm Bardac 2250, 30 | 6.79 | NT |
| ppm SLF180 | | |
| 40 ppm Bardac 205M, 40 | 6.44 | NT |
| ppm Pluronic L61 | | |
| 30 ppm Bardac 205M, 30 | 6.44 | NT |
| ppm Pluronic L61 | | |
| 30 ppm Bardac 2080 | 4.42 | NT |
| 40 ppm Bardac 2080 | 5.75 | NT |
| 50 ppm Bardac 2080 | 6.07 | NT |
| 60 ppm Bardac 2080 | 6.77 | NT |
| 90 ppm Bardac 2080 | 6.77 | NT |
| 40 ppm Bardac 2080, 40 | 5.25 | NT |
| ppm TDA3, 40 ppm SLF180 | | |
| 40 ppm Bardac 2080, 40 | 5.94 | NT |
| ppm SLF180 | | |
| 40 ppm Bardac 2080, 80 | 4.79 | NT |
| ppm SLF180 | | |
| 40 ppm Bardac 2080, 40 | 6.97 | NT |
| ppm 31R1, 100 ppm citrate | | |
| 40 ppm Bardac 2080, 40 | 6.97 | NT |
| ppm SLF180, 200 ppm | | |
| citrate | | |
| 90 ppm Bardac LF | 3.06 | NT |
| 60 ppm Bardac LF | 3.06 | NT |
| 30 ppm Bardac LF | 3.06 | NT |
| 30 ppm Bardac LF, 30 ppm | 3.05 | NT |
| SLF180 | | |
| 30 ppm Bardac LF, 30 ppm | 3.05 | NT |
| TDA3 | | |
| 30 ppm Bardac LF, 30 ppm | 3.05 | NT |
| Surfonic 24-3 | | |
| 30 ppm Bardac LF, 30 ppm | 3.05 | NT |
| Tomadol 91-2.5 | | |
| 30 ppm Bardac LF, 100 ppm | 3.29 | NT |
| EDTA | | |
| 30 ppm Bardac LF, 300 ppm | 3.29 | NT |
| EDTA | | |
| 30 ppm Bardac LF, 600 ppm | 3.29 | NT |
| EDTA | | |
| pH 4 | | |
| 30 ppm CarboQuat | 6.88 | NT |
| pH 3 | | |
| 30 ppm CarboQuat | 6.25 | NT |

The results shown in bold indicate the compositions with a passing result of greater than or equal to a 5-log reduction of tested organisms. In various tests only the E. coli was tested due to the E. coli being a gram-negative microorganism that is known to be more difficult to kill than the gram-positive S. aureus microorganism. The successful performance of various compounds against the E. coli resulted in the S. aureus microorganism not being tested to expedite the testing.

The results show an unexpected benefit of certain quaternary ammonium compounds at pH<7, namely pH 3-5, including the Bardac 2250 (didecyl dimethyl ammonium chloride), and Carboquat (didecyl dimethyl ammonium carbonate/bicarbonate) quaternary ammonium compounds beneficially perform better at lower concentrations at lower pH levels. For example, it is shown that the Bardac 2250 provides improved sanitizing efficacy at pH 5 at 30 ppm compared and pH 7 at 40-55 ppm compared to a more alkaline pH of 9 at 30-40 ppm. It is further shown that the Carboquat provides improved sanitizing efficacy at pHs 3-5 at 30 ppm compared to a more alkaline pH of 8 at 30-40 ppm. It is further shown that the Bardac 2080 provides sanitizing efficacy at pH 5 at levels of at least 40 ppm or greater (including in combination with nonionic surfactants).

In some embodiments, the blend of dioctyl dimethyl, didecyl dimethyl, octyl-decyl dimethyl, and alkyl (C8-16) dimethyl benzyl ammonium chloride provides the sanitizing efficacy at lower concentrations and/or pH when combined with a nonionic surfactant, namely a block copolymer nonionic surfactant. These tests demonstrate that the combination with defoaming surfactants and/or sheeting agents do not interfere with the microbial efficacy of the quaternary ammonium compounds. The microbial efficacy shown as log reductions in excess of 6.3-6.4 indicate a complete inactivation (and variations in reported log reduction above this are not statistically significant as complete kill has been obtained). Any variation above the complete kill reported can be caused by variations within the inoculum on a particular test date, for example.

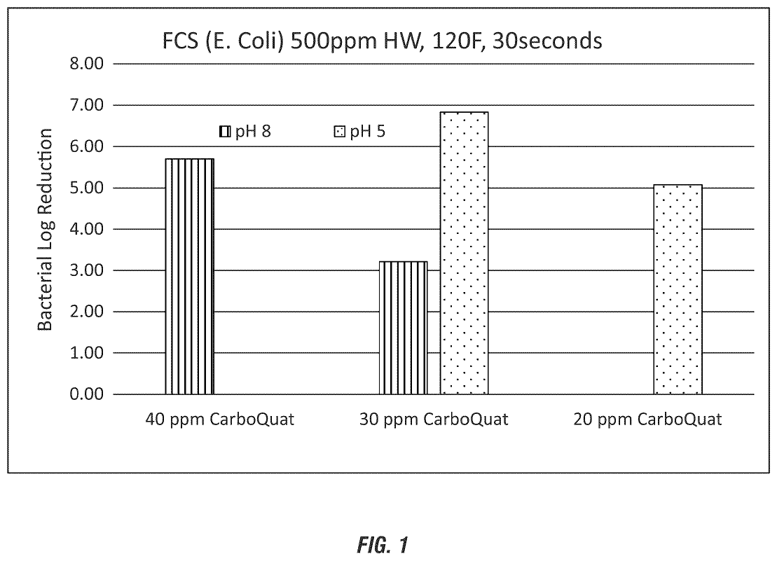

FIG. 1 depicts the comparison of the food contact sanitizing efficacy comparing the Carboquat (didecyl dimethyl ammonium carbonate/bicarbonate) at pH 8 and 5 at ppm varying from 40-20 ppm, showing that performance was increased at lower pH and with lower ppm.

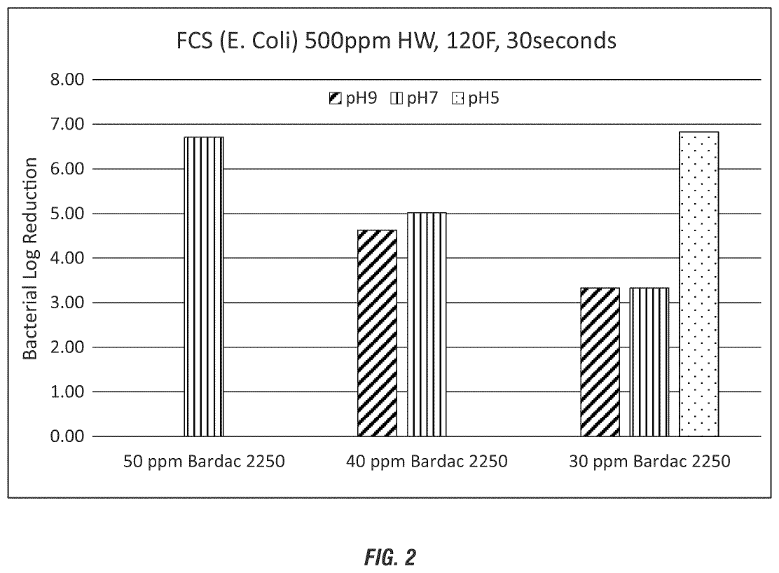

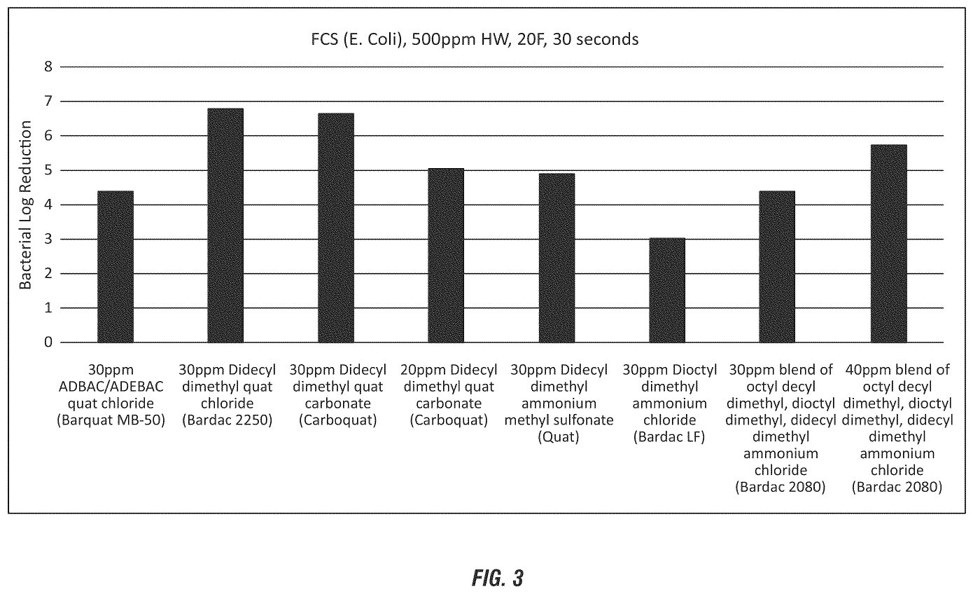

FIG. 2 further depicts the comparison of the food contact sanitizing efficacy comparing the Bardac 2250 (didecyl dimethyl ammonium chloride) at pH 9, 7 and 5 at ppm varying from 50-30 ppm, showing that performance was increased at lower pH and with lower ppm. FIG. 3 further depicts the summary of data in Example 1 for food contact sanitizing efficacy at pH 5 for the various evaluated quaternary ammonium compounds.

Table 6 shows the summary of microbial data, at 30 ppm pH 7 and 9 bacterial growth was too numerous to count (TNTC) at 120° F.

TABLE 6

| | | CFU - Dilution | | | | | Average Log |
|---|---|---|---|---|---|---|---|
| Sample | Replicate | 1E−01 | 1E−02 | CFU/mL | Log | Log Reduction | Reduction |
| 40 ppm | 1 | 224 | 35 | 2.35E+03 | 3.37 | 4.43 | 5.02 |
| Bardac 2250 | 2 | 16 | 1 | 1.5E+02 | 2.10 | 5.61 | |
| (pH 7) | | | | | | | |
| 40 ppm | 1 | 192 | 12 | 1.85E+03 | 3.27 | 4.54 | 4.63 |
| Bardac 2250 | 2 | 120 | 14 | 1.22E+03 | 3.09 | 4.72 | |
| (pH 9) | | | | | | | |
| 30 ppm | 1 | TNTC | TNTC | 3.00E+04 | 3.33 | 3.33 | 3.33 |
| Bardac 2250 | 2 | TNTC | TNTC | 3.00E+04 | 4.48 | 3.33 | |
| (pH 7) | | | | | | | |
| 30 ppm | 1 | TNTC | TNTC | 3.00E+04 | 4.48 | 3.33 | 3.33 |
| Bardac 2250 | 2 | TNTC | TNTC | 3.00E+04 | 4.48 | 3.33 | |
| (pH 9) | | | | | | | |

Table 7 shows the summary of microbial data, at 40 ppm pH 7 in the presence of a nonionic surfactant at 120° F.

TABLE 7

| | | CFU - Dilution | | | | | Average Log |
|---|---|---|---|---|---|---|---|
| Sample | Replicate | 1E−01 | 1E−02 | CFU/mL | Log | Log Reduction | Reduction |
| 40 ppm | 1 | TNTC | TNTC | 3.0E+04 | 4.48 | 3.17 | 3.17 |
| Bardac 2250, | 2 | TNTC | TNTC | 3.0E+04 | 4.48 | 3.17 | |
| 40 ppm | | | | | | | |
| SLF180 (pH 7) | | | | | | | |
| 40 ppm | 1 | TNTC | 12 | 2.2E+03 | 3.34 | 4.31 | 4.07 |
| Bardac 2250, | 2 | TNTC | 64 | 6.4E+03 | 3.81 | 3.84 | |
| 20 ppm | | | | | | | |
| SLF180, | | | | | | | |
| 20 ppm PPG | | | | | | | |
| 2000 (pH 7) | | | | | | | |

Table 8 shows the summary of microbial data, at 30 ppm pH 5 is an improvement over pH 8 at 120° F.

TABLE 8

| | | CFU - Dilution | | | | | Average Log |
|---|---|---|---|---|---|---|---|
| Sample | Replicate | 1E−01 | 1E−02 | CFU/mL | Log | Log Reduction | Reduction |
| 30 ppm CarboQuat (pH 7) | 1 | 0 | 0 | 1E+01 | 1.00 | 6.68 | 6.68 |
| | 2 | 0 | 0 | 1E+01 | 1.00 | 6.68 | |
| 30 ppm CarboQuat (pH 8) | 1 | TNTC | TNTC | 3.00E+04 | 4.48 | 3.21 | 3.21 |
| | 2 | TNTC | TNTC | 3.00E+04 | 4.48 | 3.21 | |
| 40 ppm CarboQuat (pH 8) | 1 | 4 | 0 | 4E+01 | 1.56 | 6.12 | 5.70 |
| | 2 | 27 | 1 | 2.5E+02 | 2.41 | 5.28 | |

Table 9 shows the summary of microbial data, at pH 5 for the evaluated quaternary ammonium compounds at 120° F.

TABLE 9

| | | CFU - Dilution | | | | | Average Log |
|---|---|---|---|---|---|---|---|
| Sample | Replicate | 1E−01 | 1E−02 | CFU/mL | Log | Log Reduction | Reduction |
| 30 ppm Stepan | 1 | 63 | 12 | 6.8E+02 | 2.83 | 4.85 | 4.93 |
| Quat (pH 5) | 2 | 46 | 5 | 4.6E+02 | 2.67 | 5.02 | |
| 30 ppm Bardac | 1 | TNTC | TNTC | 3.0E+04 | 4.48 | 3.06 | 3.06 |
| LF (pH 5) | 2 | TNTC | TNTC | 3.0E+04 | 4.48 | 3.06 | |
| 30 ppm Bardac | 1 | 276 | 37 | 2.8E+03 | 3.45 | 4.32 | 4.42 |
| 2080 | 2 | 180 | 14 | 1.8E+03 | 3.25 | 4.53 | |
| 40 ppm Bardac | 1 | 0 | 0 | 1.0E+01 | 1.00 | 6.67 | 5.75 |
| 2080 | 2 | 64 | 12 | 6.9E+02 | 2.84 | 4.84 | |

Table 10 shows the summary of microbial data showing that the addition of a nonionic surfactant does not affect the microbial efficacy at pH 5 at 120° F.

TABLE 10

| | | CFU - Dilution | | | | | Average Log |
|---|---|---|---|---|---|---|---|
| Sample | Replicate | 1E−01 | 1E−02 | CFU/mL | Log | Log Reduction | Reduction |
| 30 ppm Bardac 2250, | 1 | 0 | 0 | 1.0E+01 | 1.00 | 6.79 | 6.79 |
| 10 ppm SLF180, 30 ppm | 2 | 0 | 0 | 1.0E+01 | 1.00 | 6.79 | |
| PPG2000 (pH 5) | | | | | | | |
| 30 ppm Bardac 2250, | 1 | 0 | 0 | 1.0E+01 | 1.00 | 6.79 | 6.79 |
| 30 ppm PPG2000 (pH 5) | 2 | 0 | 0 | 1.0E+01 | 1.00 | 6.79 | |
| 30 ppm Bardac 2250, | 1 | 0 | 0 | 1.0E+01 | 1.00 | 6.79 | 6.79 |
| 30 ppm SLF180 (pH 5) | 2 | 0 | 0 | 1.0E+01 | 1.00 | 6.79 | |
| 40 ppm Bardac 205, | 1 | 0 | 0 | 1.0E+01 | 1.00 | 6.44 | 6.44 |
| 40 ppm Pluronic L61 (pH 5) | 2 | 0 | 0 | 1.0E+01 | 1.00 | 6.44 | |
| 30 ppm Bardac 205, | 1 | 0 | 0 | 1.0E+01 | 1.00 | 6.44 | 6.44 |
| 30 ppm Pluronic L61 (pH 5) | 2 | 0 | 0 | 1.0E+01 | 1.00 | 6.44 | |

Table 11 further shows the summary of microbial data showing that the addition of a nonionic surfactant does not affect the microbial efficacy at pH 5 at 120° F.

TABLE 11

| | | CFU - Dilution | | | | | Average Log |
|---|---|---|---|---|---|---|---|
| Sample | Replicate | 1E−01 | 1E−02 | CFU/mL | Log | Log Reduction | Reduction |
| 40 ppm Bardac 2080, | 1 | 13 | 1 | 1.4E+01 | 1.15 | 6.53 | 5.25 |
| 40 ppm TDA3, | 2 | TNTC | 51 | 5.1E+03 | 3.71 | 3.97 | |
| 40 ppm SLF180 | | | | | | | |
| 40 ppm Bardac 2080, | 1 | 32 | 1 | 3.0E+02 | 2.48 | 5.20 | 5.94 |
| 40 ppm SLF180 | 2 | 0 | 0 | 1.0E+01 | 1.00 | 6.67 | |

### Example 2

Additional micro efficacy testing was completed as described in Example 1 with the modification of the temperature at 104° F. (lower temperature than Example 1).

Table 12 shows the testing of various quaternary ammonium compounds at pHs 9, 7 and 5 to demonstrate the effect of pH on the antimicrobial efficacy of the quaternary ammonium compounds.

TABLE 12

| | E. coli | S. aureus |
|---|---|---|
| | (ATCC 11229) | (ATCC 6538) |
| pH 9 | | |
| 75 ppm CarboQuat | 6.95 | NT |
| 50 ppm CarboQuat | 5.33 | NT |
| pH 7 | | |
| 75 ppm CarboQuat | 6.95 | NT |
| 50 ppm CarboQuat | 6.71 | NT |
| 30 ppm CarboQuat | 3.47 | NT |
| pH 5 | | |
| 75 ppm CarboQuat | 6.95 | NT |
| 50 ppm CarboQuat | 6.95 | NT |
| 30 ppm CarboQuat | 5.61 | NT |

The results show further testing of Carboquat (didecyl dimethyl ammonium carbonate/bicarbonate) quaternary ammonium compound and improved antimicrobial efficacy as the pH decreased from 9 to 5 as measured by the log reduction of bacteria. For example, at 50 ppm active quat, the log reduction increased as the pH decreased.

Table 13 shows the summary of micro data, at 30 ppm pH 5 which is a significant improvement over pH 7 at 104° F.

TABLE 13

| | | CFU - Dilution | | | | | Average Log |
|---|---|---|---|---|---|---|---|
| Sample | Replicate | 1E−01 | 1E−02 | CFU/mL | Log | Log Reduction | Reduction |
| 30 ppm | 1 | TNTC | TNTC | 3.00E+04 | 4.48 | 3.47 | 3.47 |
| CarboQuat | 2 | TNTC | TNTC | 3.00E+04 | 4.48 | 3.47 | |
| (pH 7) | | | | | | | |
| 30 ppm | 1 | 14 | 3 | 1.5E+02 | 2.19 | 5.76 | 5.61 |
| CarboQuat | 2 | 28 | 6 | 3.1E+02 | 2.49 | 5.46 | |
| (pH 5) | | | | | | | |

### Example 3

Additional micro efficacy testing was completed as described in Example 1 with the modification of the temperature at 77° F. (lower temperature than Examples 1-2).

Table 14 shows the testing of various quaternary ammonium compounds at pHs 9, 7 and 5 to demonstrate the effect of pH on the antimicrobial efficacy of the quaternary ammonium compounds.

TABLE 14

| | E. coli | S. aureus |
|---|---|---|
| | (ATCC 11229) | (ATCC 6538) |
| pH 9 | | |
| 100 ppm CarboQuat | 6.83 | NT |
| 75 ppm CarboQuat | 6.50 | |
| 50 ppm CarboQuat | 3.35 | NT |
| pH 7 | | |
| 75 ppm CarboQuat | 6.83 | NT |
| 50 ppm CarboQuat | 3.35 | NT |
| pH 5 | | |
| 100 ppm CarboQuat | 6.83 | NT |
| 75 ppm CarboQuat | 6.83 | NT |
| 50 ppm CarboQuat | 6.70 | NT |

The results show further testing of Carboquat (didecyl dimethyl ammonium carbonate/bicarbonate) quaternary ammonium compound and improved antimicrobial efficacy as the pH decreased from 9 to 5 as measured by the log reduction of bacteria under lower temperature conditions.

Table 15 shows the summary of micro data, at 50 ppm pH 5 which is a significant improvement over pH 7 at 77° F.

TABLE 15

| | | CFU - Dilution | | | | | Average Log |
|---|---|---|---|---|---|---|---|
| Sample | Replicate | 1E−01 | 1E−02 | CFU/mL | Log | Log Reduction | Reduction |
| 50 ppm CarboQuat | 1 | TNTC | TNTC | 3.00E+04 | 4.48 | 3.35 | 3.35 |
| (pH 7) | 2 | TNTC | TNTC | 3.00E+04 | 4.48 | 3.35 | |
| 50 ppm CarboQuat | 1 | 2 | 0 | 2E+01 | 1.26 | 6.57 | 6.70 |
| (pH 7) | 2 | 1 | 0 | 1E+01 | 1.00 | 6.83 | |

### Example 4

Additional micro efficacy testing was completed as described in Example 1 with the modification of the temperature at 77° F. (lower temperature than Examples 1-2, same as Example 3). Table 16 shows the testing of 50 ppm CarboQuat at pH 7.5-8 (micro control water with no pH adjustment), 6, 5 and 4 to demonstrate the effect of pH on the antimicrobial efficacy of the quaternary ammonium compound on E. coli.

TABLE 16

| | | CFU - Dilution | | | | | Average Log |
|---|---|---|---|---|---|---|---|
| Sample | Replicate | 1E−01 | 1E−02 | CFU/mL | Log | Log Reduction | Reduction |
| CarboQuat 50 ppm | 1 | TNTC | TNTC | 3.0E+04 | 4.48 | 3.40 | 3.40 |
| (pH 7.5-8) | 2 | TNTC | TNTC | 3.0E+04 | 4.48 | 3.40 | |
| CarboQuat 50 ppm | 1 | 44 | 7 | 4.6E+02 | 2.67 | 5.21 | 5.22 |
| (pH 4) | 2 | 44 | 4 | 4.4E+02 | 2.64 | 5.23 | |
| CarboQuat 50 ppm | 1 | 0 | 0 | 1.0E+01 | 1.00 | 6.87 | 6.87 |
| (pH 5) | 2 | 0 | 0 | 1.0E+01 | 1.00 | 6.87 | |
| CarboQuat 50 ppm | 1 | TNTC | 84 | 8.4E+03 | 3.92 | 3.95 | 4.07 |
| (pH 6) | 2 | TNTC | 48 | 4.8E+03 | 3.68 | 4.19 | |

Table 17 shows the testing of 50 ppm CarboQuat at pH 7.5-8 (micro control water with no pH adjustment), 6, 5, and 4 to demonstrate the effect of pH on the antimicrobial efficacy of the quaternary ammonium compound on S. aureus.

TABLE 17

| | | CFU - Dilution | | | | | Average Log |
|---|---|---|---|---|---|---|---|
| Sample | Replicate | 1E−01 | 1E−02 | CFU/mL | Log | Log Reduction | Reduction |
| CarboQuat | 1 | 0 | 0 | 1.0E+01 | 1.00 | 6.89 | 6.89 |
| 50 ppm (pH 7.5-8) | 2 | 0 | 0 | 1.0E+01 | 1.00 | 6.89 | |
| CarboQuat | 1 | 0 | 0 | 1.0E+01 | 1.00 | 6.89 | 6.89 |
| 50 ppm (pH 4) | 2 | 0 | 0 | 1.0E+01 | 1.00 | 6.89 | |
| CarboQuat | 1 | 0 | 0 | 1.0E+01 | 1.00 | 6.89 | 6.89 |
| 50 ppm (pH 5) | 2 | 0 | 0 | 1.0E+01 | 1.00 | 6.89 | |
| CarboQuat | 1 | 0 | 0 | 1.0E+01 | 1.00 | 6.89 | 6.89 |
| 50 ppm (pH 6) | 2 | 0 | 8 | 1.0E+01 | 1.00 | 6.89 | |

The data in Tables 16 and 17 demonstrate complete inactivation, with 6.89 average log reduction (≥99.9999% reduction) of both E. coli and S. aureus, at pH of 5 or below. Although the results against S. aureus are achieved at higher pH as well, this is not surprising as the microorganism is more easily killed than the E. coli.

### Example 5

Data was generated to show use of the compositions described herein as a sanitizing rinse aid. Notably, sanitizing rinse use in commercial ware washing applications is dosed at a 1-2 mL per rack in a ware washing machine. For the example described herein a 1 rack dosing would be 30 ppm quaternary ammonium compound in the sanitizing rinse composition, and a 2-rack ware washing machine was used, thereby doing 60 ppm quaternary ammonium compound in the sanitizing rinse composition. This provides a customer the flexibility to dose the 1-2 mL for the micro efficacy (as demonstrated in earlier Examples at the 1 mL/30 ppm rate).

Melamine plates were processed a day before the test by washing them in an AM-15 dish machine. Plates were washed for a 4-minute wash cycle with a commercial detergent (Lime Away, available from Ecolab), followed by a freshwater rinse, then for a 4-minute cycle with commercial detergent (Guardian Plus, available from Ecolab), followed by a freshwater rinse. Plates were then washed for a 1-minute cycle in soft water and rinsed manually with DI water and left to dry overnight. For the testing, an ES2000 machine set at 120° F. and filled with soft water. A single melamine plate was loaded into a dish rack, and a 1-minute cycle was run with no detergent present. During the rinse, test solution was injected into the line as a rinse aid to achieve the active concentrations. Testing was completed using 60 ppm Bardac 2250 and 60 ppm PPG2000 at a pH 5. Three seconds after the rinse was completed, the machine was opened, the rack was removed from the machine, and a timer started. At 5 seconds and 10 seconds, photographs (and visual analysis) of the plate were taken to observe the sheeting behavior. Five plates were run for each test sample and plates were classified as no sheeting, partial sheeting, or full sheeting. This example demonstrates efficacy of the sanitizing rinse aid (consistent with results achieved at 30 ppm and also achieved in this example with the higher dosing rate of 60 ppm) and provided effective rinsing and sheeting behavior.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. In addition, the contents of all patent publications discussed supra are incorporated in their entirety by this reference.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1-9. (canceled)

10. A method of cleaning a surface comprising:
contacting a surface in need of cleaning and/or sanitizing with a sanitizing composition comprising:
between about 1 wt-% to about 70 wt-% of a quaternary ammonium compound, wherein the quaternary ammonium compound has the formula
where R₁-R₄ are alkyl groups each having a chain
length between C1-C16 and/or benzyl or alkylbenzyl group, and X— is an anionic counterion; and
between about 1 wt-% to about 90 wt-% of an acid source, wherein the acid source comprises an organic acid;
wherein the composition is a solid or a liquid concentrate composition; and
optionally wherein the composition is free of oxidizing agents:
forming use solution from the solid or liquid concentrate composition;
wherein the pH of the use solution is ≤about 5.5, and
wherein a use solution of the composition provides a quaternary ammonium compound
concentration of at least about 20 ppm or at least about 30 ppm to provide at least a 5-log (≥99.999%) reduction of microorganisms on the surface.

11. The method of claim 10, first comprising a step of forming a use solution from a solid composition by diluting the solid composition with water, or forming a use solution from a liquid concentrate by diluting the liquid concentrate composition with water.

12. The method of claim 10, wherein the pH of the concentrate and/or use composition is less than about 5, less than about 4, or less than about 3.

13. The method of claim 10, wherein the concentration of the quaternary ammonium compound is between about 20 ppm and about 50 ppm, or about 30 ppm and about 50 ppm.

14. The method of claim 10, wherein the temperature is below about 120° F., or about 120° F.

15-26. (canceled)

27. A method of cleaning a ware with a sanitizing rinse aid composition comprising:
contacting a substrate in a warewash machine with a use solution of a sanitizing rinse aid composition between about 0.5 wt-% to about 50 wt-% of a quaternary ammonium compound, wherein the quaternary ammonium compound has the formula
where R1-R4 are alkyl groups each having a chain length between C1-C16 and/or a benzyl or alkylbenzyl group, and X— is an anionic counterion;
an acid source; and
a defoaming surfactant and/or sheeting agent,
wherein the composition is a solid or a liquid concentrate composition;
optionally wherein the composition is free of oxidizing agents and/or anionic surfactants;
wherein the pH of the use composition is ≤about 5.5, and
wherein a use solution of the composition provides a quaternary ammonium compound concentration of at least about 20 ppm or at least about 30 ppm to provide at least a 5-log (≥99.999%) reduction of microorganisms on the surface.

28. The method of claim 27, wherein the pH of the use solution is less than about 5, less than about 4, or less than about 3.

29. The method of claim 27, wherein the concentration of the quaternary ammonium compound is at between about 30 ppm and about 50 ppm.

30. The method of claim 29, wherein the contacting step within the warewash machine is at a temperature of at least about 120° F.

31. The method of claim 27, wherein the substrate is ware or other surface in the warewash machine.

32. The method of claim 27, wherein the sanitizing rinse aid composition contacts the substrates in the warewash machine after a detergent composition.

33. The method of claim 32, wherein the sanitizing rinse aid composition contacts the substrates in the warewash machine without further application of a separate rinse aid to the warewash machine.

34. The method of claim 10, wherein the organic acid source comprises carboxylic acid, polycarboxylic acid or salt thereof.

35. The method of claim 10, wherein the R1-R4 alkyl groups of the quaternary ammonium compound are C1-C4 and C8-C12, or C1 and C8-C12, wherein the benzyl or alkylbenzyl group is a methyl benzyl or ethylbenzyl, and wherein the X-anionic counterion is a halide, methyl sulfate, carbonate or bicarbonate, or mixture thereof.

36. The method of claim 33, wherein the quaternary ammonium compound is an alkyl dimethyl benzyl ammonium chloride, alkyl dimethyl ethyl benzyl ammonium chloride, a dialkyl dimethyl ammonium chloride, octyl decyl dimethyl ammonium chloride, dioctyl dimethyl ammonium chloride, didecyl dimethyl ammonium chloride, didecyl dimethyl ammonium carbonate/bicarbonate, or combinations thereof.

37. The method of claim 10, wherein the composition is a liquid concentrate comprising between about 10 wt-% to about 40 wt-% of the quaternary ammonium compound, and between about 10 wt-% to about 80 wt-% of the acid source.

38. The method of claim 27, wherein the acid source is a carboxylic acid, polycarboxylic acid or salt thereof and wherein the R1-R4 alkyl groups of the quaternary ammonium compound are C1-C4 and C8-C12, or C1 and C8-C12, and wherein the benzyl or alkylbenzyl group is a methyl benzyl or ethylbenzyl, and wherein the X-anionic counterion is a halide, methyl sulfate, carbonate, bicarbonate, or mixture thereof, or wherein the quaternary ammonium compound is an alkyl dimethyl benzyl ammonium chloride, alkyl dimethyl ethyl benzyl ammonium chloride, a dialkyl dimethyl ammonium chloride, didecyl dimethyl ammonium carbonate/bicarbonate or combinations thereof.

39. The method of claim 27, wherein the defoaming surfactant is an alcohol alkoxylate, and/or wherein the sheeting agent is an alcohol ethoxylate having the following formula R—O—(CH₂CH₂O)ₙ—H, wherein R is a (C₁-C₁₂) alkyl group and n is an integer in the range of 1 to 100.

40. The method of claim 27, wherein the rinse aid composition is a liquid concentrate comprising between about 10 wt-% to about 50 wt-% of the quaternary ammonium compound, between about 1 wt-% to about 50 wt-% of the acid source, and between about 0.5 wt-% to about 15 wt-% of the defoaming surfactant and/or between about 0.1 wt-% to about 15 wt-% of the sheeting agent.

41. The method of claim 27, wherein the rinse aid composition is a solid comprising between about 1 wt-% to about 30 wt-% of the quaternary ammonium compound, between about 1 wt-% to about 90 wt-% of the acid source, between about 0.5 wt-% to about 15 wt-% of the defoaming surfactant, and further comprising a builder and/or filler in an amount between about 10 wt-% to about 80 wt-%.
